(19) United States
(12) Patent Application Publication
(10) Pub. No.: US 2026/0044854 A1
(43) Pub. Date: Feb. 12, 2026

(54) DETECTING AN ANOMALOUS ACTIVITY IN A TRANSACTION DATA STRUCTURE

(71) Applicant: American Express Travel Related Services Company, Inc., New York, NY (US)

(72) Inventors: Shailendra GUPTA, Gurgaon (IN); Ashi Kalra SAWHNEY, Gurgaon (IN); Anshul JAIN, Gurgaon (IN); Vishal MALHOTRA, Gurgaon (IN); Varun SAXENA, Gwalior (IN); Megha GROVER, New Delhi (IN)

(73) Assignee: American Express Travel Related Services Company, Inc., New York, NY (US)

(21) Appl. No.: 18/800,960

(22) Filed: Aug. 12, 2024

(51) Int. Cl. G06Q 20/40

(52) U.S. Cl. CPC G06Q 20/401

(57) ABSTRACT

Disclosed herein are system, method, and computer program product embodiments for detecting an anomalous activity in a data structure. The method includes acquiring, by at least one processor, merchant category data and a plurality of authorized transactions, training an embedding model using the merchant category data. The embedding model receives an input merchant category for a transaction and generates a sentence embedding for the input merchant category. The method further comprises training an autoencoder using the plurality of authorized transactions. The autoencoder receives transaction data for the transaction and generates a similarity score for the transaction compared to the plurality of authorized transactions. The method further comprises generating a trained machine learning model that is configured to generate transaction scores and flag transactions based on the transaction scores. The trained machine learning model comprises the trained embedding model and the trained autoencoder.

### TECHNICAL FIELD

Aspects relate to systems and methods for detecting an anomalous activity in a data structure.

### BACKGROUND

Payment card accounts are widely used by customers to pay for in-store purchase transactions, online shopping transactions, bill payments, and other purposes. A payment card account may be associated with and managed by a company that is separate from a user of the card, such as a corporate card or a small business credit card. Designated employees of the company can use the payment card account for authorized business expenses, such as travel, entertainment, and office supplies. An issuer of the payment card account may assign a merchant category code to a merchant in order to classify individual transactions according to the type of merchant. The merchant category code may be used for a variety of purposes, including determining a fee to charge for the issuer services and calculation and issuance of credit card rewards. These companies typically approve or decline purchases by their designated employees based on these merchant category codes. Typical approval processes relied on manual scoring of the category codes to determine a level of risk associated with each purchase.

### SUMMARY

Disclosed herein are system, apparatus, device, method and/or computer program product embodiments, and/or combinations and sub-combinations thereof, for flagging, approving or declining transactions associated with a corporate card by using an improved model for detecting anomalous activity in a transaction data structure.

In some embodiments, a method may comprise acquiring, by at least one processor, merchant category data and a plurality of authorized transactions, training an embedding model using the merchant category data. The embedding model receives an input merchant category for a transaction and generates a sentence embedding for the input merchant category. The method further comprises training an autoencoder using the plurality of authorized transactions. The autoencoder receives transaction data for the transaction and generates a similarity score for the transaction compared to the plurality of authorized transactions. The method further comprises generating a trained machine learning model that is configured to generate transaction scores and flag transactions based on the transaction scores. The trained machine learning model comprises the trained embedding model and the trained autoencoder.

In some embodiments, a system comprises a memory and at least one processor coupled to the memory. The at least one processor is configured to acquire merchant category data and a plurality of authorized transactions and train an embedding model using the merchant category data. The embedding model receives an input merchant category for a transaction and generates a sentence embedding for the input merchant category. The at least one processor is further configured to train an autoencoder using the plurality of authorized transactions and generate a trained machine learning model that is configured to generate transaction scores and flag transactions based on the transaction scores. The trained machine learning model comprises the trained embedding model and the trained autoencoder. The autoencoder receives transaction data for the transaction and generates a similarity score for the transaction compared to the plurality of authorized transactions.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the art to make and use the aspects.

FIG. 1 is a block diagram of an environment for a detection platform, in accordance with an embodiment of the present disclosure.

FIG. 2 is a schematic that illustrates an anchor based similarity approach, in accordance with an embodiment of the present disclosure.

FIG. 3 is a table that shows risk scores associated with different merchant categories, in accordance with an embodiment of the present disclosure.

FIG. 4 is a schematic that illustrates an autoencoder, in accordance with an embodiment of the present disclosure.

FIG. 5A is a table that shows an out of pattern index for a plurality of merchant categories, in accordance with an embodiment of the present disclosure.

FIG. 5B is a table that shows the out of pattern index for the plurality of merchant categories with similar merchant categories grouped together, in accordance with an embodiment of the present disclosure.

FIG. 5C is a table that shows the out of pattern index for the plurality of merchant categories with similar merchant categories grouped together, in accordance with an embodiment of the present disclosure.

FIG. 6 is an example method for flagging a transaction, in accordance with an embodiment of the present disclosure.

FIG. 7 is an example method for determining a transaction score, in accordance with an embodiment of the present disclosure.

FIG. 8 is an example method for generating a trained artificial intelligence model, in accordance with an embodiment of the present disclosure.

FIG. 9 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Aspects of the present disclosure relate to detecting an anomalous activity in a data structure, for example, a system for flagging unauthorized or ineligible transactions.

The following aspects are described in sufficient detail to enable those skilled in the art to make and use the disclosure. It is to be understood that other aspects are evident based on the present disclosure, and that system, process, or mechanical changes may be made without departing from the scope of an aspect of the present disclosure.

In the following description, numerous specific details are given to provide a thorough understanding of aspects. However, it will be apparent that aspects may be practiced without these specific details. To avoid obscuring an aspect, some well-known circuits, system configurations, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the system may be operated in any orientation.

Certain aspects have other steps or elements in addition to or in place of those mentioned. The steps or elements will become apparent to those skilled in the art from a reading of the following detailed description when taken with reference to the accompanying drawings.

As discussed in the background section, some transactions may not be authorized or eligible to be charged on a company payment card. A risk score may be associated with a merchant category code. For example, a low risk score may be assigned to eligible merchant categories such as corporate travel and a high risk score may be assigned to ineligible merchant categories such as jewelry stores. Based on the risk score, an unauthorized transaction may be flagged. However, manually assigning a risk score to each merchant category code is inaccurate and impractical as further discussed below. Each issuer of payment card may use a different classification system and each merchant category code may comprise a plurality of sub-categories. For example, one merchant category may include up to 2000 categories at a granular level. Further, authorized or eligible transactions may vary between companies and between employees. Thus, manually assigning a risk score for each merchant category and sub-categories and for a plurality of different classification systems is time consuming and prone to errors. Using inaccurate risk scores leads to errors in flagging transactions (e.g., flagging an authorized transaction).

What is needed is systems and methods to address the aforementioned problems, and to provide improved techniques for accurately detecting an anomalous activity in the transaction data structure comprising a plurality of transactions. The anomalous activity may correspond to an unauthorized transaction or an ineligible transaction. Embodiments described herein have the advantage of automatically assigning an accurate risk score for the merchant category codes and sub-categories thus saving on manual time investment as well as reducing the risk of errors.

The present disclosure provides an improvement in the technologies of payment processing and data structure by providing improved training data sets that solves the above-noted technological problems. In addition, the risk assessment may be performed much faster and with increased accuracy at the granular level because the process is not tied to manual risk assessment. By storing data associated with the plurality of transactions in the transaction data structure, more accurate risk scores may be determined and assigned to each transaction at a category level and at company level. The data may be efficiently processed and accessed to determine an out of pattern index at a granular level as further described below. The out of pattern index for a merchant category is more accurate as the data in the transaction data structure is continuously updated and the machine learning model may be retrained based on the updated data. By using machine learning techniques such as word embeddings, syntactical and semantic information in the merchant categories are preserved. In addition, by analyzing the transaction data structure to generate a training dataset at a granular level and target specific, the performance of the machine learning model is improved.

As mentioned above, a risk score for a transaction that is a function of the risk score of the merchant category and transaction data (e.g., recency and transaction value) may fail to detect out of pattern transactions. Embodiments described herein uses machine learning techniques to determine an out of pattern index using for the transaction data structure. An autoencoder is trained using a plurality of authorized transactions (e.g., eligible transactions). The autoencoder generates a similarity score for the transaction compared to the plurality of authorized transactions. The out of pattern index may be used by a trained machined learning model in addition to the risk score and transaction data to accurately flag unauthorized transactions.

In addition, the process may not be applied mentally, it requires at least a processor to acquire and analyze relations for a large number of transactions. It is not practical or feasible to acquire and process the transactions and associated information by a human mind because determining risk scores includes using a machine learning model to determine a cosine similarity for the large number of categories. In addition, it is not possible for a human mind to analyze a huge number of transactions that occurs via a payment processing network to determine out of pattern transactions.

Various embodiments of these features will now be discussed with respect to the corresponding figures.

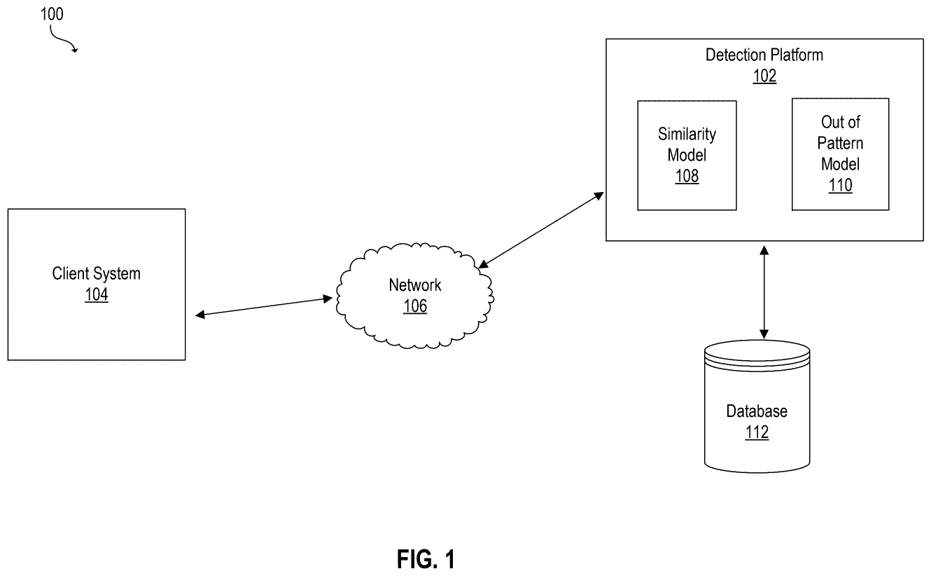

FIG. 1 is a block diagram of an environment 100 for a detection platform 102, in accordance with an embodiment of the present disclosure. Environment 100 may include detection platform 102, a client system 104, a network 106, and a database 112.

In some aspects, detection platform 102 may generate a trained machine leaning model that flags a transaction by a payment card member (e.g., corporate card member). In some aspects, the flagged transaction may correspond to an ineligible spend by the payment card member. The transaction may be a non-business related transaction such as a non-travel and entertainment spend (e.g., personal shopping) by the payment card member.

Detection platform 102 may receive transaction data from client system 104 via network 106. In some aspects, client system 104 may collect the transactions for each of the payment cards for a company. In other aspects, client system 104 may collect the transactions from a plurality of companies. For example, the client system 104 may be associated with an issuer of the payment card. Transaction data may include a plurality of transactions associated with one or more customers (e.g., authorized users of the payment card). For each transaction of the plurality of transactions, the transaction data may include a date of the transaction, a spend amount, and a category of the transaction. Detection platform 102 may analyze transaction data and may flag one or more transactions. Detection platform 102 may output the flagged transactions to client system 104. In some aspects, detection platform 102 may generate a visual interface with visual elements associated with flagged transactions. Examples of visual elements include highlights, modifying coloring, text properties of the flagged transaction on the visual interface. In some aspects, detection platform 102 may acquire transaction data associated with one or more transactions on a continuous basis. For example, after transaction data of a transaction are received at client system 104, detection platform 102 may acquire the transaction data for analysis. In some aspects, the transaction data for a plurality of transactions may be received in batches periodically.

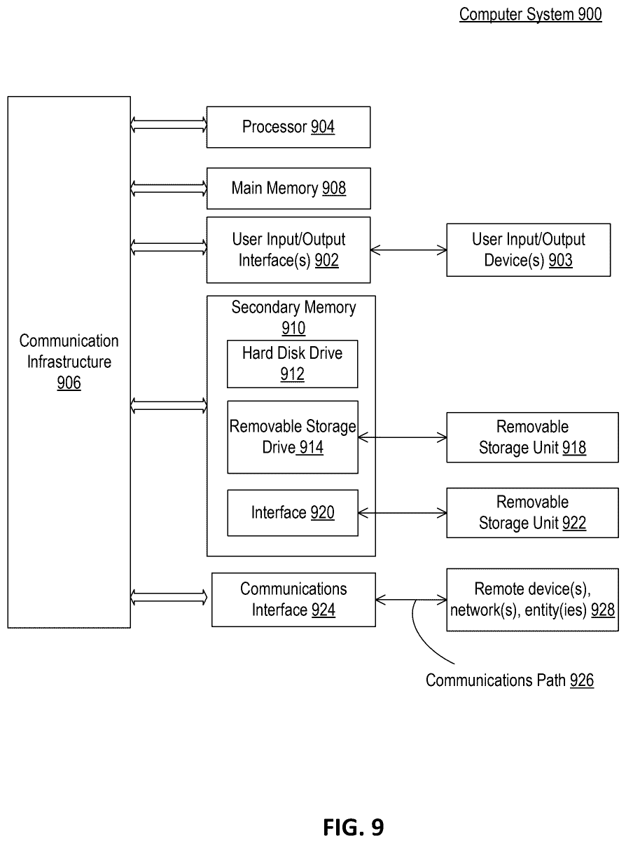

Detection platform 102 may operate on one or more servers and/or databases. The servers may be a variety of centralized or decentralized computing devices. For example, a server may be grid-computing resources, a virtualized computing resource, peer-to-peer distributed computing devices, a mobile device, a laptop computer, a desktop computer, or a combination thereof. The servers may be centralized in a single room, distributed across different rooms, distributed across different geographic locations, or embedded within network 106. In some aspects, detection platform 102 may be implemented using computer system 900 described with reference to FIG. 9. Detection platform 102 may provide a cluster computing platform or a cloud computing platform to analyze transaction data acquired from client system 104.

After receiving the transaction data from client system 104, detection platform 102 may extract transaction data at a sub-category level. Detection platform 102 may group the transaction in custom groups and calculate a z-score associated with the transaction values for the custom groups. In some aspects, risk scores associated with the customs groups are custom for each company. A risk score that is associated with a custom group may be customized by the company. Risk scores are customized based on data from each individual company such that different companies can have different risk score for a custom category (e.g., a first company A may have different risk score for a custom category for its employees compared to a second company B). This is different from the prior art because the companies had to rely on static scores for the purchases because of the impracticality of customizing risk scores to the merchant category. Detection platform 102 may determine a transaction score for a transaction of the plurality of transactions. The transaction score may indicative of whether the transaction is an authorized (e.g., eligible transaction) or whether the transaction is not authorized. In some aspects, the higher the transaction score the higher the probability that the transaction is not authorized is. In some aspects, detection platform 102 may analyze the transaction data using a similarity model 108 and an out of pattern model 110. Based on the transaction score, detection platform 102 may flag the transaction as unauthorized. In some aspects, the transaction score is compared with a threshold value. If the transaction score exceeds the threshold value, then detection platform 102 may flag the transaction. The threshold value may be stored in database 112. As described above, corporate credit cards may have preset rules on the type of the transactions that may be charged to the account. Accurately flagging the transaction may reduce the risk of continuous loss for the corporation.

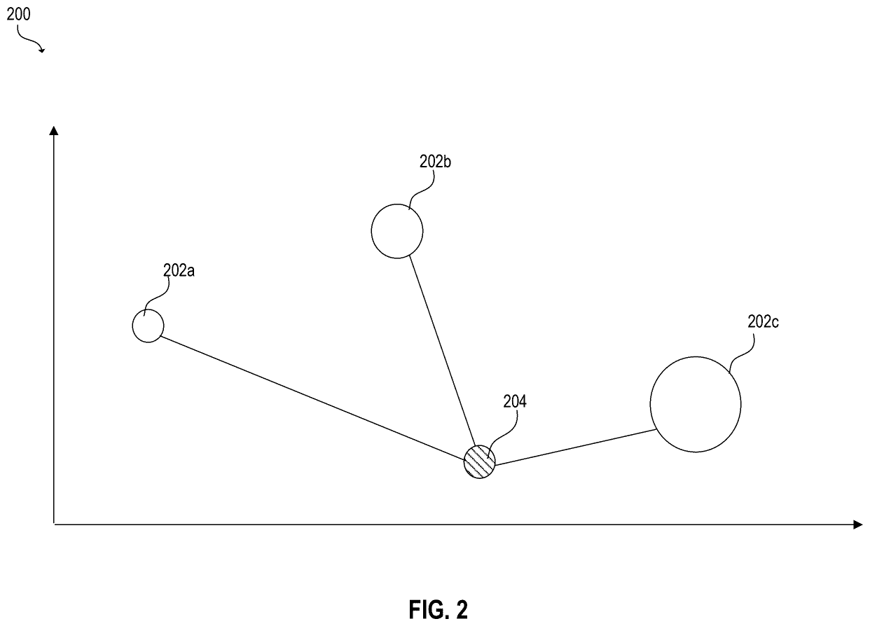

In order to determine the transaction score for a transaction, similarity model 108 may apply a machine learning technique. In some aspects, similarity model 108 may include an embedding model. The embedding model may generate a vector representation (e.g., a sentence embedding) for the input merchant category that corresponds to the transaction. In some aspects, the machine learning technique may include a natural language processing (NLP) algorithm (e.g., sentence transformers, Word2Vec, fastText, gloVe, Bidirectional Encoder Representations from Transformers (BERT)). Then, similarity model 108 may identify one or more anchor points and may determine a risk score or weight for the input merchant category. Detection platform 102 may determine cosine similarities with the input merchant category. The anchor based similarity technique is further described in relation to FIG. 2.

In some aspects, embedding model may receive an input merchant category and generates the vector representation for the input merchant category. Embedding model may be trained on a large dataset such as Google news, Wikipedia, and the like. In some aspects, similarity model 108 may be fine tuned or retrained by training on a target dataset that includes the categories and sub-categories used by an issuer of the payment card. Training using the target dataset provides the advantage of obtaining accurate embeddings and therefore a more accurate risk score for the input merchant category.

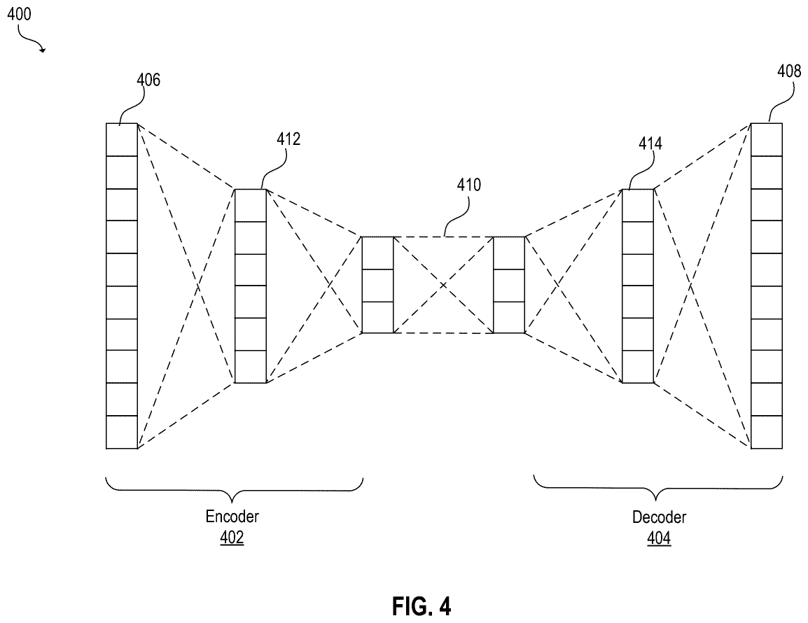

In addition to determining the risk score, detection platform 102 may analyze transaction data to identify an out of pattern transaction. Detection platform 102 may determine an out of pattern index for the transaction. In some aspects, detection platform 102 may determine the out of pattern index using out of pattern model 110. To detect out of pattern transactions, out of pattern model 110 may implement an anomaly detection technique. Out of pattern model 110 may be trained on transaction level embeddings of merchant categories. In some aspects, out of pattern model 110 may be trained on embeddings of authorized or eligible merchant categories. In some aspects, out of pattern model 110 may include an autoencoder. The autoencoder may output a learned representation of the transaction category. In some aspects, out of pattern model 110 may include a replicator neural network, a variational autoencoder, a Bayesian network, a hidden Markov model, or a deep learning model (e.g., a convolutional neural network or a simple recurrent unit). Out of pattern model 110 may determine a similarity between the learned representation and an input feature associated with the transaction (e.g., input merchant category). In some aspects, a cosine similarity between the original embeddings and the reconstructed or learned embeddings may be used to obtain the out of pattern score. Based on the similarity, out of pattern model 110 may determine the out of pattern index. Out of pattern model 110 is further described in relation to FIG. 4.

Using at least the outputs from similarity model 108 and out of pattern model 110, detection platform 102 may determine the transaction score. By determining the transaction score based on outputs from similarity model 108 and out of pattern model 110, an accurate risk score is used for each merchant category. In addition, the accuracy of the transaction score is improved at a custom level (e.g., for a particular company or for a particular user) by determining the out of pattern score. The transaction score may also depend on the z-score of a transaction value, recency of the transaction, and the predefined weight associated with the respective merchant category (e.g., associated with the super or broad category). In some aspects, the transaction score may be expressed as:

$$Transaction score = zscore \times {( Weights \times ML based weights )}^{3 / 2} \times recency \times Out of pattern Index$$

The z-score may indicate a relationship between the value of the transaction and the mean of other transaction values. For example, an average of the transaction values may be determined. The average of the transaction values may be target specific (e.g., average transaction values for a specific time period for all transactions of designated employees). The weights may correspond to manual weights assigned to the merchant category (e.g., to the broad category to which the sub-category belongs). The ML based weight may correspond to the weights obtained from similarity model 108. Recency may correspond to an index that reflects the time of last transaction. The out of pattern index may correspond to the output of out of pattern model 110. The z-score, the weights, and the ML based weights may be specified in the data structure (e.g., a JavaScript® Object Notation (JSON® object)).

Client system 104 may be a user device accessing detection platform 102 via network 106. Client system 104 may be a workstation and/or user device used to access, communicate with, and/or manipulate detection platform 102. In some aspects, client system 104 may be associated with an issuer of the payment card (e.g., corporate card) or a company of the designated employee using the payment card. Client system 104 may access detection platform 102 using a client interface. The client interface may be an interface for presenting and/or receiving information to/from a user. An interface may be a communication interface such as a command window, a web browser, a display, and/or any other type of interface. Other software, hardware, and/or interfaces may be used to provide communication between the user and detection platform 102. For example, the client interface may be a web portal that provides a web page or website to the user for viewing and interaction. The web portal may be located at a web address accessible via a web browser, and may be supported by one or more servers (e.g., computer system 900 as further described with reference to FIG. 9). The website may be a graphical user interface (GUI) provided by detection platform 102 and/or via an application programing interface (API) provided by detection platform 102.

As used herein, the API may comprise any software capable of performing an interaction between one or more software components as well as interacting with and/or accessing one or more data storage elements (e.g., server systems, databases, hard drives, and the like). An API may comprise a library that specifies routines, data structures, object classes, variables, and the like. Thus, an API may be formulated in a variety of ways and based upon a variety of specifications or standards, including, for example, POSIX, the MICROSOFT WINDOWS API®, a standard library such as C++, a JAVA API, and the like.

Client system 104, detection platform 102, and database 112 may communicate via network 106. Network 106 may be a telecommunications network, such as a wired or wireless network. Network 106 can span and represent a variety of networks and network topologies. For example, network 106 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in network 106. Cable, Ethernet, digital subscriber line (DSL), fiber optic lines, fiber to the home (FTTH), and plain old telephone service (POTS) are examples of wired communication that may be included in network 106. Further, network 106 can traverse a number of topologies and distances. For example, network 106 can include a direct connection, personal area network (PAN), local area network (LAN), metropolitan area network (MAN), wide area network (WAN), or a combination thereof.

As described above, similarity model 108 may use sentence embedding to generate a vector representation of words, phrases, or sentences in an n-dimensional space. Words, phrases, or sentences that share similar meaning are clustered closer together (e.g., king and queen) in the vector space whereas words, phrases, or sentences that have different meanings (e.g., king and apple) are away from each other. The vector representation is obtained for the input merchant category (e.g., from the name or description of the input merchant category) in the n-dimensional space.

FIG. 2 is a schematic that shows a vector representation 200 of a plurality of merchant categories, in accordance with an embodiment of the present disclosure. Vector representation 200 comprises a plurality of merchant categories (e.g., 202a, 202b, 202c). Although the vector representation 200 is shown in a 2-dimensional space, it is understood that the vector representation may be in the n-dimensional space.

In some aspects, a risk score is associated with each merchant category of the plurality of merchant categories. For example, a risk score of 2 may be associated with a first merchant category 202a “corporate travel”, a risk score of 5 may be associated with a second merchant category 202b “retail”, and a risk score of 8 may be associated with a third merchant category 202c “salon.” The risk score of each category may be scored manually. The plurality of merchant categories that are scored manually may represent broad grouping of merchant categories or super categories. Each broad group or super category may include a plurality of granular merchant categories. As discussed above, it may not be possible to assign a risk score accurately for each granular merchant category.

For an input merchant category 204 e.g., “cosmetic stores,” a similarity metric is determined between input merchant category 204 and each broad category. Input merchant category 204 may represent a granular merchant category that may not have an associated risk score stored in database 112. The vector representation of the input merchant category may be obtained by the embedding model. As shown in vector representation 200, input merchant category 204 “cosmetic stores” is near third merchant category 202c as they are similar. The broad categories may represent anchors to the input merchant category. In some aspects, a cosine similarity is measured from each anchor point to the input merchant category. The similarity metric may be a function of a dot product between respective vectors of the anchor category and the input merchant category. The risk score associated with input merchant category 204 may be determined as a function of the similarity scores. In some aspects, the risk score may be a weighted average of the risk scores associated with the merchant categories.

In some aspects, for an input category 204 “cosmetic stores,” a similarity score with each of the merchant categories is determined. A first similarity score s1 is determined between the first merchant category 202a “corporate travel” and input merchant category 204 “cosmetic stores.” A second similarity score s2 is determined between the second merchant category 202b “retail” and input merchant category 204 “cosmetic stores.” A third similarity score s3 is determined between the third merchant category 202c “salon” and input merchant category 204 “cosmetic stores”. The risk score for input merchant category 204 may be determined as a weighted average of the risk scores of first merchant category 202a, second merchant category 202b, and third merchant category 202c. The weights may correspond to the similarity scores. For example, the risk score for input merchant category 204 may be determined as:

$$Risk score ( input category ) = \frac{Risk score 1 \times s 1 + Risk score 2 \times s 2 + Risk score 3 + s 3}{s 1 + s 2 + s 3}$$

In some aspects, detection platform 102 may rank the merchant categories based on the similarity scores with the input merchant category. The weighted average may be determined using the top-k categories as anchor points. In some aspects, the top-3 categories are used in the weighted average calculation as shown in the example above.

As described above, a category may include multiple sub-genesis. Some sub-categories may correspond to authorized transactions while some sub-categories may correspond to unauthorized transactions. A manual weight may associate a risk score for all the sub-categories. However, such risk score may be inaccurate for some of the sub-categories. For example, a risk score of 5 may be assigned to merchant category “retail”. The merchant category “retail” may include more than 100 diverse sub-genesis. For example, merchant category “retail” includes sub-category “grocery stores,” “eating places,” and sub-category “toiletries cosmetics and perfumes.” “Grocery stores” or “eating places” are less likely to be associated with an unauthorized transaction compared to “toiletries cosmetics and perfumes.” Thus, assigning the same risk score to all sub-genesis in a category is inaccurate and may lead to flagging an authorized transaction as unauthorized.

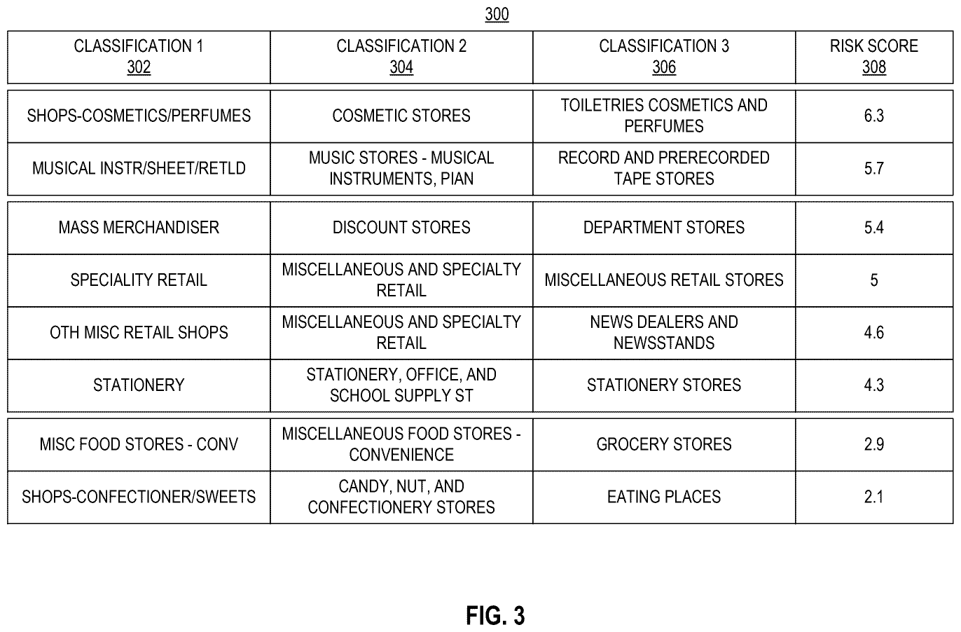

FIG. 3 is a table 300 that shows a risk score for a plurality of categories, in accordance with an embodiment of the present disclosure. Transactions may be classified using different types of classification systems (e.g., sub-genesis, sub merchant category code (sub-mcc), 4 or 8 digits standard industrial classification (SIC4 or SIC8) or card issuer specific classification). Table 300 shows a first classification type 302, a second classification type 304, and a third classification type 306. All merchant categories shown in table 300 are sub-categories of the merchant category “retail.” In conventional systems, the same risk score is assigned to all the sub-categories. Detection platform 102 may assign a risk score 308 for each sub-category of “retail” in each classification system (e.g., first classification type 302, second classification type 304, and third classification type 306). Using similarity model 108, an accurate risk score is assigned to each sub-category. As shown in table 300, merchant category “toiletries, cosmetics, and perfumes” is assigned a risk score of 6.3 whereas merchant category “eating places” is assigned a risk score of 2.1. The assigned risk scores are more accurate compared to assigning the same risk score to both “toiletries, cosmetics, and perfumes” and “eating places” as sub-categories of retail.

As discussed above in addition to the risk score, detection platform 102 may also determine an out of pattern score for the transaction. Out of pattern model 110 may include a machine learning model that determines the out of pattern score for the transaction. In some aspects, out of pattern model 110 may include an autoencoder.

FIG. 4 is a block diagram of an autoencoder 400, in accordance with an embodiment of the present disclosure. In some aspects, autoencoder 400 may include a neural network. Autoencoder 400 may include an encoder 402, a decoder 404, and a latent space 410.

Autoencoder 400 is trained to copy an input to an output. In some aspects, autoencoder 400 may be trained using data associated with a plurality of transactions (e.g., merchant categories of the plurality of transactions). The plurality of transactions may be eligible transactions or authorized transactions. In some aspects, the data may comprise an embedding associated with the eligible merchant categories. In some aspects, in-pattern embeddings can be learned perfectly but out of pattern embeddings are learned imperfectly. Thus, autoencoder 400 may learn an eligible merchant category more accurately compared to an unauthorized merchant category. Reconstructed embeddings may be compared with original embeddings to get the out of pattern index. If the reconstructed embeddings and the original embeddings are similar, then the embeddings are associated with an eligible merchant category. However, if the reconstructed embedding and the original embeddings are dissimilar (e.g., high reconstruction error), then the embeddings are associated with an unauthorized merchant category.

Encoder 402 may comprise an input layer 406 and a first hidden layer 412. Input layer 406 may receive input data (e.g., vector representation of a merchant category). First hidden layer 412 receives the output of input layer 406 and process the output by a probabilistic encoder. In some aspects, first hidden layer 412 may comprise a plurality of fully connected layers. In some aspects, latent space 410 includes a latent representation of the input. In some aspects, latent space 410 can comprises one or more latent variables that represent a compressed version of the input. Decoder 404 may comprise a second hidden layer 414 and an output layer 408. Decoder 404 may recreate the input from the latent representation. Second hidden layer 414 may include a plurality of fully connected hidden layers.

In some aspects, each layer of first hidden layer 412 may include a number of nodes. The number of nodes may decrease with each layer and may reach a minimum at latent space 410. In some aspects, each layer of second hidden layer 414 may include a number of nodes. The number of nodes may increase with each layer of second hidden layer 414. In some aspects, the weights of the layers may be initialized randomly and are learned through training on the training data (e.g., embeddings of eligible transactions). In some aspects, training dataset of autoencoder 400 may include transaction-level embeddings of merchant categories. The weights may be changed through backpropagation with respect to a loss function. The loss function may measure a reconstruction loss between the input and the output.

A similarity metric is determined between the input of autoencoder 400 and the output of autoencoder 400. The out of pattern index may be determined based on the similarity metric. The similarity metric may be a cosine similarity between original embeddings and reconstructed/learned embeddings. In some aspects, the out of pattern (OOP) index may be expressed as: OOP Index=1-similarity metric. As discussed above, if the transaction information (e.g., category or value of the transaction) is out of pattern, the similarity metric will be low and the out of pattern index will be high. As explained above, the similarity metric will be low because autoencoder 400 is not trained on similar transaction information.

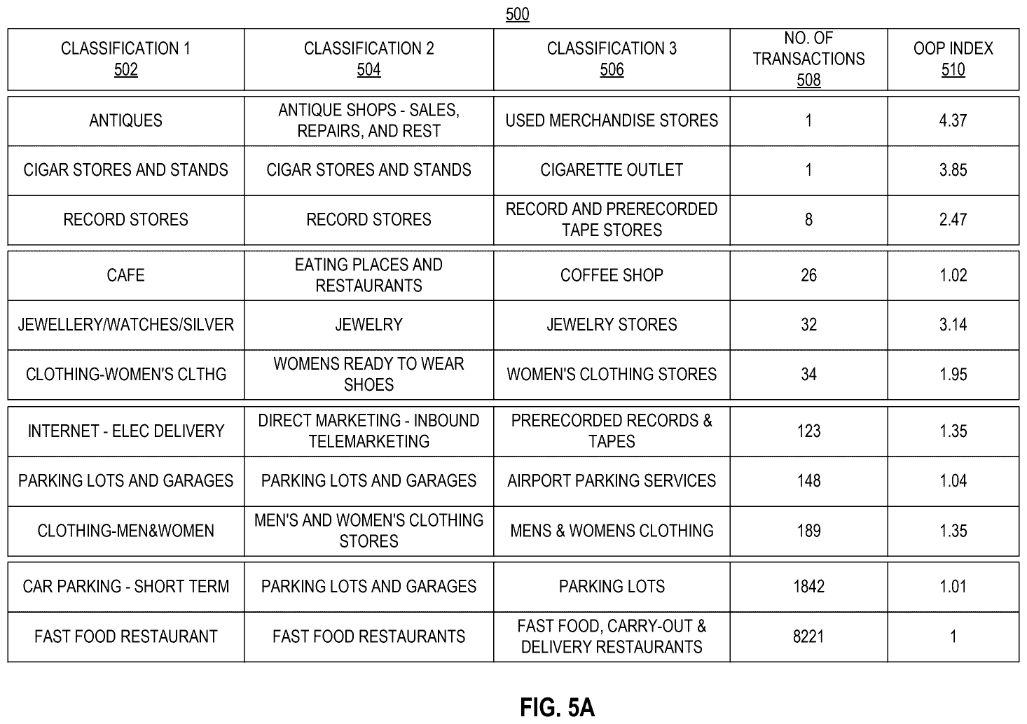

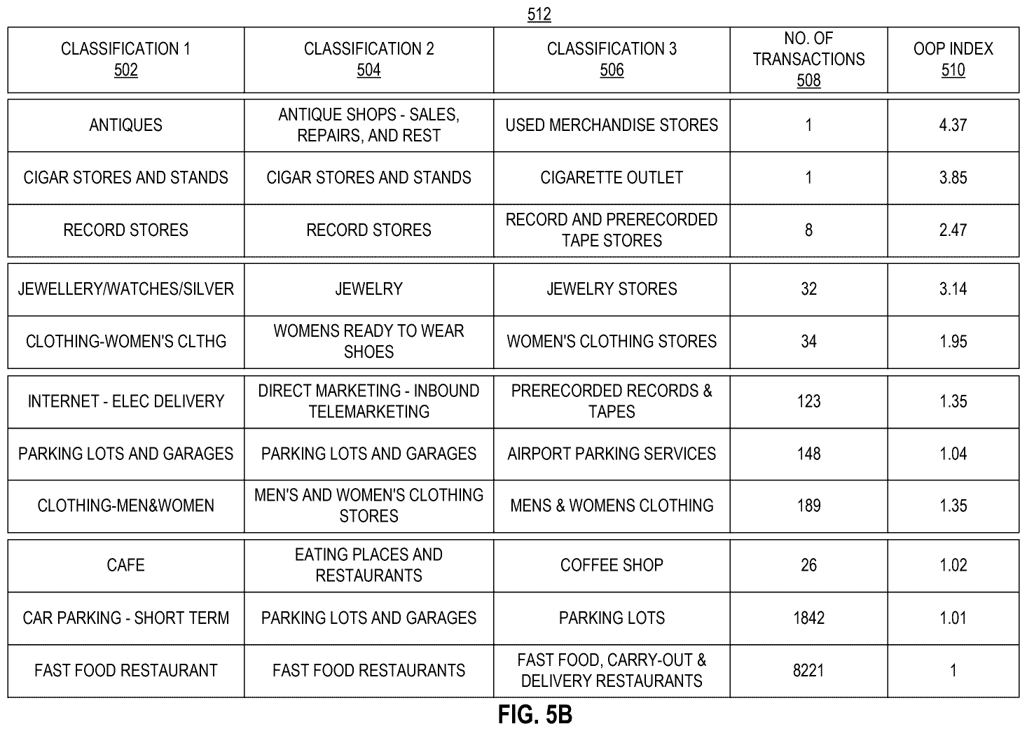

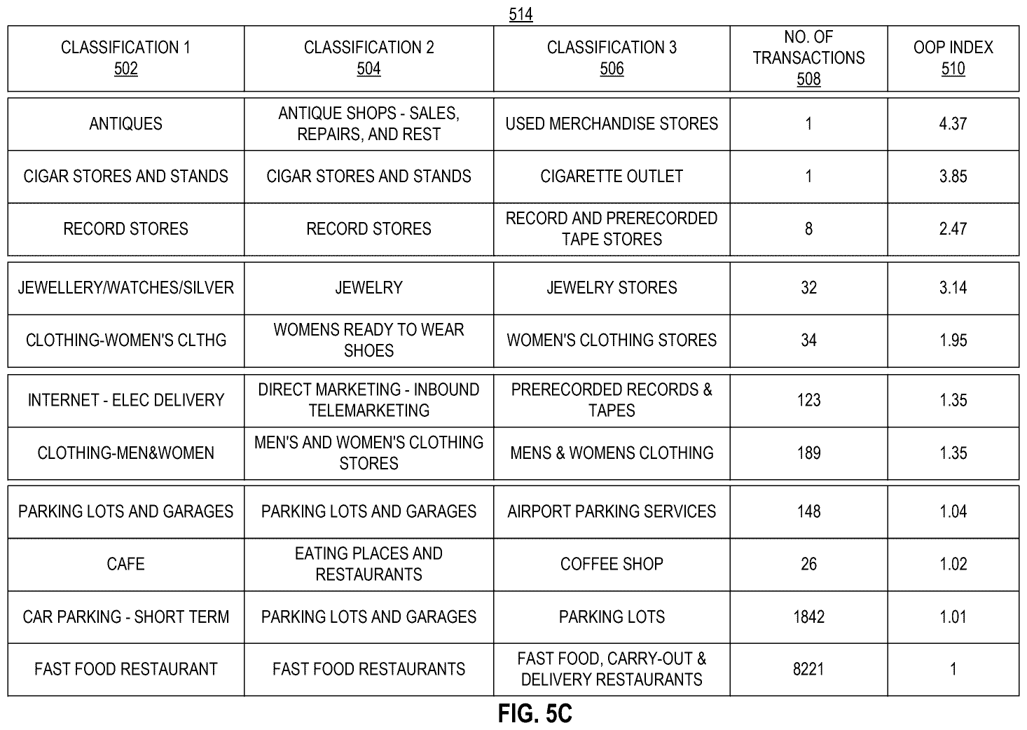

FIG. 5A is a table 500 that shows the out of pattern index for a plurality of merchant categories, in accordance with an embodiment of the present disclosure. Detection platform 102 may determine an OOP index 510 for a plurality of merchant categories using out of pattern model 110. Table 500 shows the merchant categories using different classification systems: first classification system 502, second classification system 504, and third classification system 506. Table 500 shows the number of transactions in each merchant category for a time period (e.g., transaction data received from client system 104). Table 500 shows the transactions sorted by the number of transactions in each category.

In some aspects, as shown in table 500, OOP index 510 is not correlated to the number of transactions. For example, similar merchant categories may have a similar out of pattern index regardless of the number of transactions.

FIG. 5B is a table 512 that shows the OOP index 510 for the plurality of merchant categories with similar merchant categories grouped together, in accordance with an embodiment of the present disclosure. Merchant category “Café” is grouped with “fast food restaurant” and has a similar OOP index regardless of the number of transactions in the category. In the example shown in table 512, merchant category “café” has 26 transactions while merchant category “fast food restaurant” has 8221 transactions. However, both merchant categories have similar OOP index (about 1). Similarly as shown in table 514 in FIG. 5C, merchant category “parking lots and garages” and merchant category “car parking-short term” have similar OOP index although the respective number of transactions for each category is different from each other. Thus, using the trained out of pattern model 110 to determine an OOP index provides the advantage of identifying a more accurate risk score for each merchant category regardless of the number of transactions.

### Methods of Operation

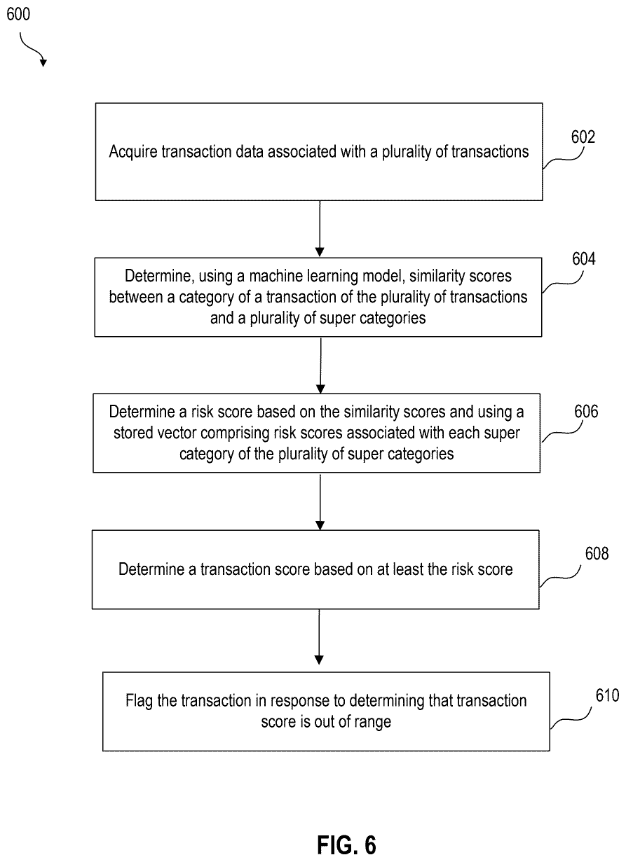

FIG. 6 is an example method 600 for flagging a transaction, in accordance with an embodiment of the present disclosure.

Method 600 may be performed as a series of steps by a computing unit such as a processor. For example, method 600 may be implemented by detection platform 102 and/or computer system 900 of FIG. 9. Method 600 shall be described with reference to FIG. 1, however, method 600 is not limited to that example embodiment. In some embodiments, detection platform may be integrated within a corporate enterprise network of the company of the user or an issuer of the payment card. Detection platform 102 may be located centrally. In some aspects, detecting platform 102 may be integrated with client system 104.

In 602, detection platform 102 may acquire transaction data associated with a plurality of transactions (e.g., from client system 104). In some aspects, the plurality of transactions may be associated with a plurality of customers. The transaction data may include a date of the transaction, a spend amount, and a category of the transaction.

In 604, detection platform 102 may use a machine learning model to determine similarity scores between a category of a transaction of the plurality of transactions and a plurality of super categories. The category of the transaction may correspond to a sub-category. The super category may correspond to broad categories. For example, the category of the transaction may correspond to “cosmetic stores” and the super category may correspond to “retail”.

In 606, detection platform 102 may determine a risk score based on the similarity scores using a stored vector comprising risk scores associated with each super category of the plurality of super categories. For example, risk scores may be assigned and stored in a vector or other type of data structures. Detection platform 102 may retrieve the risk scores for the super category and determine the risk score for the sub-category based on the similarity scores and respective risk score of the broad or super categories. In some aspects, detection platform 102 may determine the similarity scores may correspond to cosine similarities with the sub-category.

In 608, detection platform 102 may determine the transaction score as a function of at least the risk score. In some aspects, the transaction score is based on the similarity score, z-score of a transaction value, and a recency of the transaction.

In 610, detection platform 102 may flag the transaction in response to determining that the transaction score is out of range. In some aspects, to determine whether the transaction score is out of range, detection platform 102 may compare the transaction score with the threshold score stored in database 112. In some aspects, detection platform 102 may output the flagged transactions to a client system.

It is to be appreciated that not all steps may be needed to perform the disclosure provided herein. Further, some of the steps may be performed simultaneously, or in a different order than shown in FIG. 6, as will be understood be a person of ordinary skill in the art.

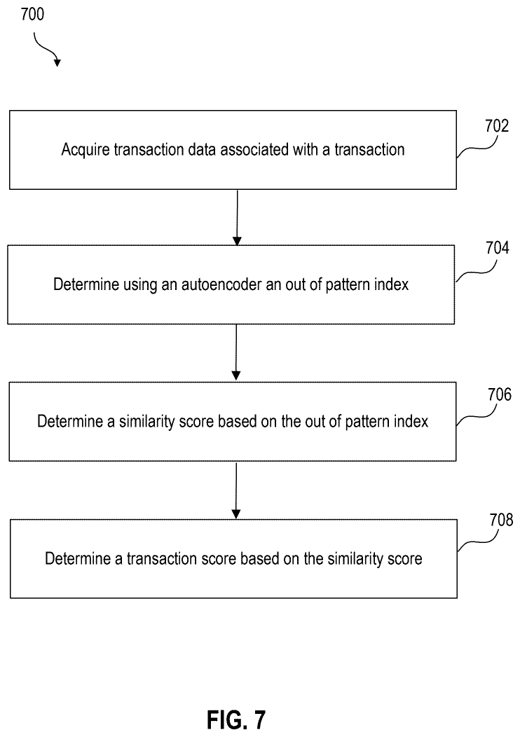

FIG. 7 is an example method 700 for determining a transaction score, in accordance with an embodiment of the present disclosure.

Method 700 may be performed as a series of steps by a computing unit such as a processor. For example, method 700 may be implemented by detection platform 102 and/or computer system 900 of FIG. 9. Method 700 shall be described with reference to FIG. 1, however, method 700 is not limited to that example embodiment.

In 702, detection platform 102 may acquire transaction data associated with a transaction. In some aspects, transaction data may correspond to a plurality of transactions associated with one or more payment cards. Detection platform 102 may receive the transaction data from client system 104. Transaction data may correspond to all the transactions for a payment card for a time period (e.g., 3 months). Transaction data may comprise a transaction value and a merchant category for each transaction. Detection platform 102 may acquire the transaction data from client system 104.

In 704, detection platform 102 may determine an out of pattern index using an autoencoder. The autoencoder may determine a similarity score between the transaction and the plurality of authorized transactions. The plurality of authorized transactions and the transaction may be associated with the same account. In some aspects, detection platform 102 may determine the out of pattern index using out of pattern model 110.

In 706, detection platform 102 may determine a similarity score based on the out of pattern index. In some aspects, out of pattern model 110 may determine a similarity between the learned representation and an input feature associated with the transaction (e.g., input merchant category).

In 708, detection platform 102 may determine a transaction score based on the similarity score. In some aspects, the transaction score is a function of the out of pattern index and other factors including the risk score, the transaction value, and the recency of the transaction.

It is to be appreciated that not all steps may be needed to perform the disclosure provided herein. Further, some of the steps may be performed simultaneously, or in a different order than shown in FIG. 7, as will be understood be a person of ordinary skill in the art.

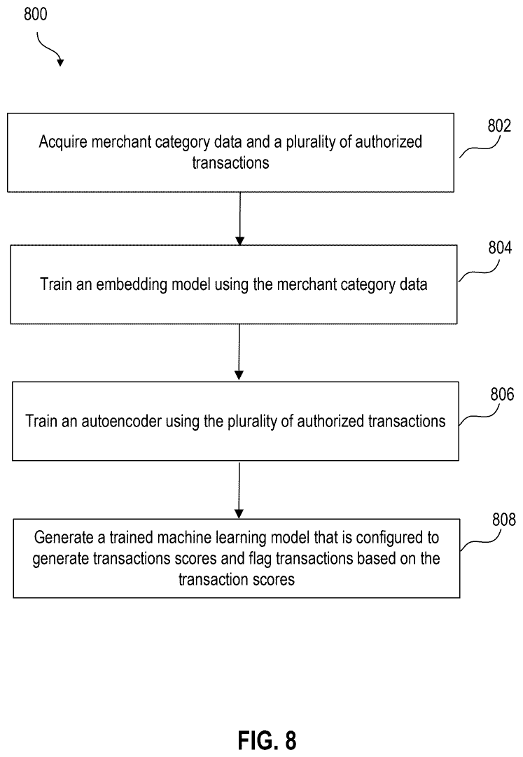

FIG. 8 is an example method 800 for generating a trained artificial intelligence model, in accordance with an embodiment of the present disclosure.

Method 800 may be performed as a series of steps by a computing unit such as a processor. For example, method 800 may be implemented by detection platform 102 and/or computer system 900 of FIG. 9. Method 800 shall be described with reference to FIG. 1, however, method 800 is not limited to that example embodiment.

In 802, detection platform 102 may acquire merchant category data and a plurality of authorized transactions. Detection platform 102 may acquire the merchant category data and the plurality of authorized transactions from client system 104.

In 804, detection platform 102 may train an embedding model using the merchant category data. The embedding model receives an input merchant category for a transaction and generates a sentence embedding for the input merchant category. In some aspects, the embedding model may be trained using sentence transformer. In some aspects, the embedding may include a transformer network (e.g., BERT) and a pooling layer. The transformer network may generate contextualized word embeddings from the input. The pooling layer may apply a pooling technique (e.g., mean-pooling) to obtain the vector representation. The embedding model may be trained using a dataset that comprises a category (e.g., a super category) and the corresponding granular categories. In addition, the dataset may include merchant category from different classification types. A label that indicates the semantic similarity between the merchant categories may be associated with each merchant category. The embedding model may be trained using a Siamese network architecture. For example, the similarity between two input categories may be determined using cosine similarity and compared with a gold similarity score.

In 806, detection platform 102 may train an autoencoder using the plurality of authorized transactions. The autoencoder receives transaction data for the transaction and generates a similarity score for the transaction compared to the plurality of authorized transactions. As discussed above, the autoencoder may be trained to minimize a loss function that measures a reconstruction between an input of the autoencoder and an output of the autoencoder. The autoencoder may be a variational autoencoder (e.g., autoencoder 400).

In 808, detection platform 102 may generate a trained machine learning model that is configured to generate transaction scores and flag transactions based on the transaction scores. The trained machine learning model comprises the trained embedding model and the trained autoencoder (e.g., autoencoder 400).

It is to be appreciated that not all steps may be needed to perform the disclosure provided herein. Further, some of the steps may be performed simultaneously, or in a different order than shown in FIG. 8, as will be understood be a person of ordinary skill in the art.

### Components of the System

Various embodiments may be implemented, for example, using one or more well-known computer systems, such as computer system 900 shown in FIG. 9. One or more computer systems 900 may be used, for example, to implement any of the embodiments discussed herein, as well as combinations and sub-combinations thereof. For example, the method steps of FIGS. 6, 7, and 8 may be implemented via computer system 900.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method, comprising:
acquiring, by at least one processor, merchant category data and a plurality of authorized transactions;
training, using the at least one processor, an embedding model using the merchant category data, wherein the embedding model receives an input merchant category for a transaction and generates a sentence embedding for the input merchant category;
training, using the at least one processor, an autoencoder using the plurality of authorized transactions, wherein the autoencoder receives transaction data for the transaction and generates a similarity score for the transaction compared to the plurality of authorized transactions; and
generating, using the at least one processor, a trained machine learning model that is configured to generate transaction scores and flag transactions based on the transaction scores, wherein the trained machine learning model comprises the trained embedding model and the trained autoencoder.

2. The method of claim 1, wherein the merchant category data comprises a plurality of super categories, the method further comprising:
acquiring the transaction data associated with a plurality of transactions;
determining, using the trained machine learning model, the similarity score between a category of the transaction of the plurality of transactions and the plurality of super categories;
determining a risk score based on the similarity scores using a stored vector comprising risk scores associated with each super category of the plurality of super categories;
determining the transaction score based on at least the risk score; and
in response to determining that the transaction score is out of range, flagging the transaction.

3. The method of claim 2, further comprising:
determining an out of pattern index for the transaction; and
determining the transaction score as a function of at least the risk score and the out of pattern index.

4. The method of claim 3, wherein the determining the out of pattern index further comprises:
determining, using the autoencoder, the similarity score between the transaction and the plurality of authorized transactions, wherein the plurality of authorized transactions and the transaction are associated with a same account; and
determining the out of pattern index as a function of the similarity score.

5. The method of claim 2, further comprising:
inputting a set of features into to the trained machine learning model, wherein the set of features comprises at least the category of the transaction.

6. The method of claim 2, wherein determining the risk score further comprises:
generating a vector representation of the category and the super categories based on a determined similarity to one another.

7. The method of claim 2, wherein the transaction score is further based on a transaction value and a recency of the transaction.

8. The method of claim 1, wherein the embedding model comprises a sentence transformers model.

9. The method of claim 7, further comprising:
retraining the sentence transformers model using a data set, wherein the data set comprises transaction categories from different classification systems.

10. A system, comprising:
a memory; and
at least one processor coupled to the memory and configured to:
acquire merchant category data and a plurality of authorized transactions;
train an embedding model using the merchant category data, wherein the embedding model receives an input merchant category for a transaction and generates a sentence embedding for the input merchant category;
train an autoencoder using the plurality of authorized transactions, wherein the autoencoder receives transaction data for the transaction and generates a similarity score for the transaction compared to the plurality of authorized transactions; and
generate a trained machine learning model that is configured to generate transaction scores and flag transactions based on the transaction scores, wherein the trained machine learning model comprises the trained embedding model and the trained autoencoder.

11. The system of claim 10, wherein the merchant category data comprises a plurality of super categories, and the at least one processor is further configured to:
acquire the transaction data associated with a plurality of transactions;
determine, using the trained machine learning model, the similarity score between a category of the transaction of the plurality of transactions and the plurality of super categories;
determine a risk score based on the similarity scores using a stored vector comprising risk scores associated with each super category of the plurality of super categories;
determine the transaction score based on at least the risk score; and
in response to determining that the transaction score is out of range, flag the transaction.

12. The system of claim 11, wherein the at least one processor is further configured to:
determine an out of pattern index for the transaction; and
determine the transaction score as a function of at least the risk score and the out of pattern index.

13. The system of claim 12, wherein to determine the out of pattern index further the at least one processor is further configured to:
determine, using the autoencoder, the similarity score between the transaction and the plurality of authorized transactions, wherein the plurality of authorized transactions and the transaction are associated with a same account; and
determine the out of pattern index as a function of the similarity score.

14. The system of claim 11, wherein the at least one processor is further configured to:
input a set of features into to the trained machine learning model, wherein the set of features comprises at least the category of the transaction.

15. The system of claim 11, wherein to determine the risk score the at least one processor is further configured to:
generate a vector representation of the category and the super categories based on a determined similarity to one another.

16. The system of claim 10, wherein the transaction score is further based on a transaction value and a recency of the transaction.

17. The system of claim 10, wherein the embedding model comprises a sentence transformers model.

18. The system of claim 17, wherein the at least one processor is further configured to:
retrain the sentence transformers model using a data set, wherein the data set comprises transaction categories from different classification systems.

19. A non-transitory computer-readable device having instructions stored thereon that, when executed by at least one computing device, cause the at least one computing device to perform operations comprising:
acquiring merchant category data and a plurality of authorized transactions;
training an embedding model using the merchant category data, wherein the embedding model receives an input merchant category for a transaction and generates a sentence embedding for the input merchant category;
training an autoencoder using the plurality of authorized transactions, wherein the autoencoder receives transaction data for the transaction and generates a similarity score for the transaction compared to the plurality of authorized transactions; and
generating a trained machine learning model that is configured to generate transaction scores and flag transactions based on the transaction scores, wherein the trained machine learning model comprises the trained embedding model and the trained autoencoder.

20. The non-transitory computer-readable device of claim 16, wherein determining the risk score further comprises:
acquiring the transaction data associated with a plurality of transactions;
determining, using the trained machine learning model, the similarity score between a category of the transaction of the plurality of transactions and the plurality of super categories;
determining a risk score based on the similarity scores using a stored vector comprising risk scores associated with each super category of the plurality of super categories;
determining the transaction score based on at least the risk score; and
in response to determining that the transaction score is out of range, flagging the transaction.
